(19) United States
(12) Patent Application Publication
(10) Pub. No.: US 2014/0236445 A1
(43) Pub. Date: Aug. 21, 2014

(54) Method for Estimating Tire Parameters for a Vehicle

(71) Applicant: Nico Dzuibek, Frankfurt (DE)

(72) Inventor: Nico Dzuibek, Frankfurt (DE)

(21) Appl. No.: 14/343,981

(22) PCT Filed: Sep. 12, 2012
(86) PCT No.: PCT/EP2012/067869

§ 371 Date: Mar. 10, 2014

(30) Foreign Application Priority Data
Sep. 12, 2011 (DE) 102011082534.7
Sep. 12, 2011 (DE) 102011082549.5
Nov. 21, 2011 (DE) 102011086710.4
May 2, 2012 (DE) 102012207297.7

(51) Int. Cl. G06F 15/00

(52) U.S. Cl. CPC G06F 15/00
USPC 701/70; 701/1

(57) ABSTRACT

A method for estimating tire parameters for a vehicle, including measuring a reference movement for the vehicle and modeling a model movement for the vehicle on the basis of a model that does not include the tire parameters to be estimated, and estimating the tire parameters of the vehicle on the basis of a juxtaposition of the reference movement and the model movement.

### CROSS REFERENCE TO RELATED APPLICATIONS

This application claims priority to German Patent Application Nos. 10 2011 082 534.7, filed Sep. 12, 2011; 10 2011 082 549.5, filed Sep. 12, 2011; 10 2011 086 710.4, filed Nov. 21, 2011; 10 2012 207 297.7, filed May 2, 2012; and PCT/EP2012/067869, filed Sep. 12, 2012.

### FIELD OF THE INVENTION

The invention relates to a method for estimating tire parameters for a vehicle, to a control apparatus for performing the method and to a vehicle having the control apparatus.

### BACKGROUND AND INTRODUCTORY DESCRIPTION OF THE INVENTION

WO 2011/098 333 A1 discloses the practice of using various sensor variables in a vehicle in order to improve already existent sensor variables or to generate new sensor variables and hence to enhance the capturable information.

It is an object to improve the use of a plurality of sensor variables in order to enhance information.

The object is achieved by the features of the methods described herein.

According to one aspect of the invention, a method for estimating tire parameters for a vehicle includes the steps of:
measurement of a reference movement for the vehicle;
modeling of a model movement for the vehicle on the basis of a model that is freed of the tire parameters to be estimated; and
estimation of the tire parameters of the vehicle on the basis of a juxtaposition of the reference movement and the model movement.

A reference movement is intended to be understood to mean a movement of the vehicle that is detected by measurement techniques with an accuracy that is considered to be adequate for further information processing in the vehicle. By contrast, the model movement is intended to be a movement of the vehicle that may differ from the reference movement with an error. The movement is subsequently intended to be understood to mean at least of the variables that are able to influence a position of the vehicle in space over time. These variables are particularly the acceleration, the speed and the roll rates of the vehicle, which may include a yaw rate, a roll rate and a pitch rate.

The specified method is based on the consideration that the generation of new sensor data or the increase in the quality of already existent sensor data on the basis of redundantly captured information in the vehicle presupposes an exact model of the vehicle. However, this exact model requires information about the contact of the wheels of the vehicle with the road on which the wheels run. This information is called tire parameters below and includes the drift stiffness, the slip stiffness and the tire radii of the wheels. The tire parameters are not fixed variables, but rather are dependent on many factors, such as temperature, humidity, road condition, and so on.

The idea behind the specified method is that if the movement is a sufficiently good reflection of reality for known tire parameters, an error between the model movement of the vehicle and a reference movement of the vehicle must stem from an error in the tire parameters. In other words, the actual tire parameter can be compiled from the tire parameter used in the model and an error between the modeled movement and the actual movement.

Within the context of the specified method, the model that is freed of the tire parameters to be estimated is intended to be not a model that is completely free of tire parameters but rather a model in which it is unknown whether or not the tire parameters used are correct. Therefore, the tire parameters used are different than the tire parameters to be estimated. In addition, the performance of the estimation is not limited to the juxtaposition. By way of example, the estimation may include the juxtaposition of the reference movement and the model movement and subsequent updating of the tire parameters used, which have a correction value that results from the juxtaposition applied to them. Alternatively, the estimation itself can result in the sought tire parameters that are to be estimated.

In one development, the specified method includes the step of detection of the reference speed of the vehicle at wheel contact points for the vehicle. This development is based on the consideration that the model speed of the vehicle could be modeled on the basis of an odometry model, which receives the wheel speeds of the individual wheels with the tire parameters to be estimated as input variables. For greatest possible accuracy of the estimation results, the speed of the vehicle should therefore also be detected at the locations of the detected wheel speeds and hence at the wheel contact points. The speed at the wheel contact points can be detected by detecting a vehicle speed at any point on the vehicle, said vehicle speed then being converted into the corresponding speeds at the wheel contact points using known vehicle parameters, such as track width, wheel base and distances to the origin of coordinates.

In another development, the specified method includes the step of setup of the model that is freed of the tire parameters to be estimated on the basis of approximated tire parameters.

In one particular development, the specified method includes the step of use of the estimated tire parameters as approximated tire parameters in the model, in order to estimate new tire parameters. This means that the specified method is performed iteratively, with a starting value initially being prescribed for the tire parameters to be estimated. Whenever the tire parameters have been estimated afresh, they are then used as a starting value for a new estimation, as a result of which the estimated tire parameters ultimately converge toward the actual tire parameters of the vehicle.

In an additional development, the specified method includes the steps of:
detection of a variance in the reference movement, and
modeling of the movement of the vehicle on the basis of the detected variance.

The variance of a signal is known to indicate the information-carrying power of the signal. Since the movement of the vehicle cannot change suddenly, this means that the variance in the measured movement should be small. Therefore, the variance itself can be used as a measure of the noise in the measured movement in order to take this into account when modeling the movement, for example.

In an additional development of the specified method, the estimated tire parameters of the vehicle are considered to be valid only if the reference movement and/or the model movement exceed a particular value. This development is based on the consideration that particularly detection of the reference movement by measurement techniques is subject to tolerances and errors that can become very large on account of noise, particularly in small measurement ranges of the sensor. Therefore, for a lower measurement range of a sensor that is involved in detection of the reference movement and/or possibly in modeling of the model movement, the sensor signal from said sensor is very inaccurate, for which reason the estimated tire parameters must also be very inaccurate. On this assumption, it is an idea of the development to use the estimation results for the tire parameters only when, as a constraint, the movement of the vehicle exceeds a particular threshold value. With particular preference, an overall acceleration of the vehicle should be greater than 5 m/s² in this case. If the vehicle is not moving at all, there can additionally be no statements about the tire parameters either.

In yet another development, the specified method includes the step of juxtaposition of the real movement and the modeled movement on the basis of an observer. Such an observer may include any filter that permits analog or digital state observation of the vehicle. By way of example, a Luenberger observer can be used. If the noise also needs to be taken into account, a Kalman filter would be suitable. If the shape of the noise also needs to be taken into account, it would be possible, if need be, to use a particle filter, which has a basic set of available noise scenarios and selects the noise scenario to be taken into account for the elimination using a Monte Carlo simulation, for example.

In one particular development, the observer is a Kalman filter, which provides an optimum result in respect of the computation resources that it requires.

According to a further aspect of the invention, a control apparatus is set up to perform a specified method.

In one development of the specified control apparatus, the specified apparatus has a memory and a processor. In this case, the specified method is stored in the memory in the form of a computer program and the processor is provided for the purpose of executing the method when the computer program is loaded from the memory into the processor.

According to a further aspect of the invention, a computer program includes program code means in order to perform all the steps of one of the specified methods when the computer program is executed on a computer or one of the specified apparatuses.

According to a further aspect of the invention, a computer program product contains a program code that is stored on a computer-readable data storage medium and that, when executed on a data processing device, performs one of the specified methods.

According to a further aspect of the invention, a vehicle includes a specified control apparatus.

### BRIEF DESCRIPTION OF THE DRAWINGS

The properties, features and advantages of this invention that are described above and also the manner in which these are achieved become more clearly and more distinctly comprehensible in connection with the description below of the exemplary embodiments, which are explained in more detail in connection with the drawings, in which:

FIG. 1 shows a basic illustration of a vehicle with a fusion sensor,

FIG. 2 shows a basic illustration of the fusion sensor from FIG. 1, and

FIG. 3 shows a tire parameter characteristic.

In the figures, technical elements that are the same are provided with the same reference symbols and are described only once.

### FURTHER DESCRIPTION OF THE INVENTION

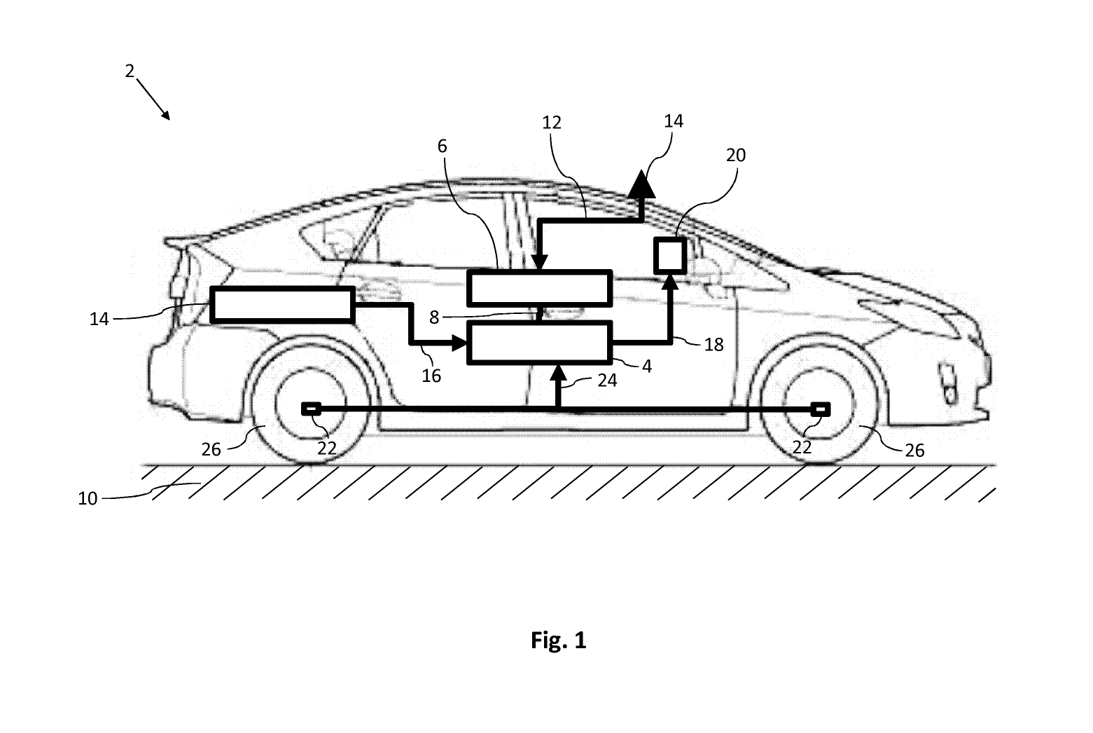

Reference is made to FIG. 1, which shows a basic illustration of a vehicle 2 with a fusion sensor 4.

In the present embodiment, the fusion sensor 4 uses an inherently known GNSS receiver 6 to receive position data 8 for the vehicle 2 that specify an absolute position for the vehicle 2 on a road 10. In the present embodiment, these position data 8 are derived—in a manner that is known to a person skilled in the art—in the GNSS receiver 6 from a GNSS signal 12 that is received via a GNSS antenna 14. For details in this regard, reference is made to the relevant specialist literature in this regard.

The fusion sensor 4 is designed—in a manner that is yet to be described to enhance the information content of the position data 8 derived from the GNSS signal 12. This is firstly necessary because the GNSS signal 12 may have a very high signal-to-noise ratio and may thus be very inaccurate. Secondly, the GNSS signal 12 is not always available.

In the present embodiment, the vehicle 2 also has an inertial sensor 14 that captures driving dynamics data 16 from the vehicle 2. These are known to include a longitudinal acceleration, a lateral acceleration and also a vertical acceleration and a roll rate, a pitch rate and also a yaw rate for the vehicle 2. In the present embodiment, these driving dynamics data 16 are used in order to enhance the information content of the position data 8 and to define the position of the vehicle 2 on the road 10 more precisely. The more precisely defined position 18 can then be used by a navigation appliance 20 even when the GNSS signal 12 is not available at all, for example in a tunnel.

To further enhance the information content of the position data 8, the present embodiment also makes use of wheel speed sensors 22 that detect the wheel speeds 24 of the individual wheels 26 of the vehicle 2.

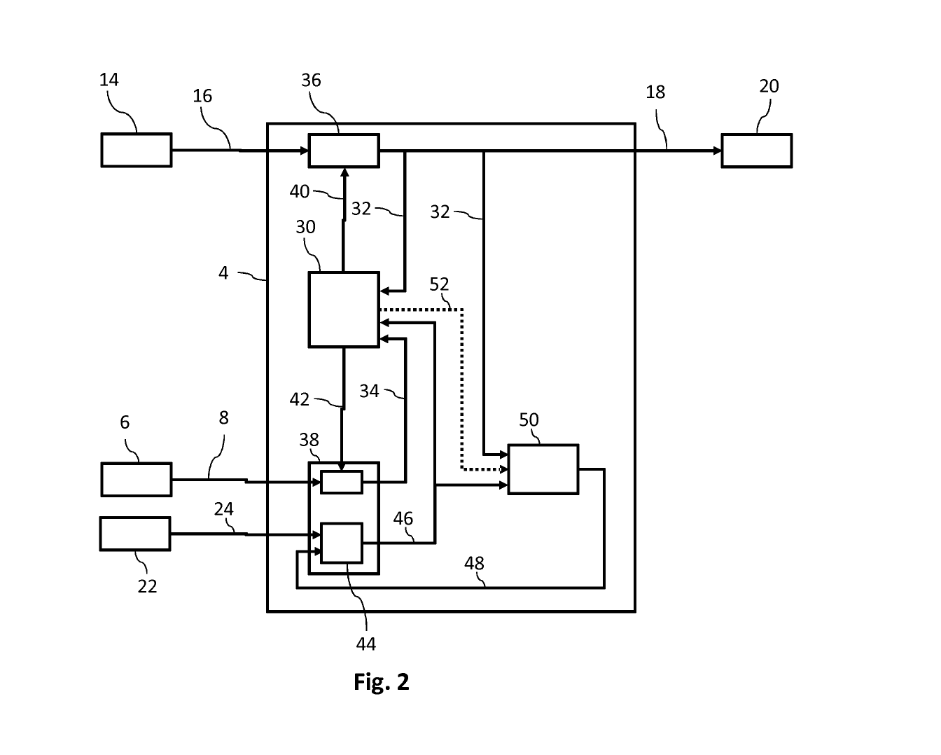

Reference is made to FIG. 2, which shows a basic illustration of the fusion sensor 4 from FIG. 1.

The fusion sensor 4 receives the measurement data already mentioned in FIG. 1. The fusion sensor 4 is intended to output the more precisely defined position data 8. The basic concept in this regard is that of juxtaposing the information from the position data 8 from the GNSS receiver 6 with the driving dynamics data 16 from the inertial sensor 14 into a filter 30 and thus increasing a signal-to-noise ratio in the position data 8 from the GNSS receiver 6 or the driving dynamics data 16 from the inertial sensor 14. To this end, although the filter may be in any form, a Kalman filter achieves this object most effectively with comparatively low computation resource requirement. Therefore, the filter 30 below will preferably be a Kalman filter 30.

The Kalman filter 30 receives location data 32 for the vehicle 2 and comparison location data 34 for the vehicle 2. In the present embodiment, the location data 32 are generated from the driving dynamics data 16 using a strapdown algorithm 36, which is known from DE 10 2006 029 148 A1 which is hereby incorporated by reference, for example. They contain the more precisely defined position information 18, but also other location data about the vehicle 2, such as the speed thereof, the acceleration thereof and the heading thereof. By contrast, the comparison location data 34 are obtained from a model 38 of the vehicle 2 that is first of all fed with the position data 8 from the GNSS receiver 6. These position data 8 are then used in the model 38 to determine the comparison location data 34, which contain the same information as the location data 32. The location data 32 and the comparison location data 34 differ only in terms of their values.

The Kalman filter 30 takes the location data 32 and the comparison location data 34 as a basis for calculating an error budget 40 for the location data 32 and an error budget 42 for the comparison location data. An error budget is intended to be understood below to mean an overall error in a signal, which is made up of various individual errors during the detection and transmission of the signal. In the case of the GNSS signal 12 and hence in the case of the position data 8, a corresponding error budget may be made up of errors in the satellite orbit, in the satellite clock, in the residual refraction effects and of errors in the GNSS receiver 6.

The error budget 40 for the location data 32 and the error budget 42 for the comparison location data 34 are then supplied as appropriate to the strapdown algorithm 36 and to the model 38 for correcting the location data 32 or the comparison location data 34. This means that the location data 32 and the comparison location data 34 are iteratively purged of their errors.

In the present embodiment, the model 38 includes an odometry model 44, which is known to a person skilled in the art, that is designed to determine the additional comparison location data 46 from the wheel speeds 24 from the wheel speed sensors 22 and a steering angle—not illustrated further—of the vehicle 2. The accuracy of the odometry model 44 in the model 38 is dependent on the extent to which tire parameters such as drift stiffness, slip stiffness and tire radius are known for the wheels 26 of the vehicle. Since these tire parameters are dependent on a state of the wheels 26 and the road 10, these tire parameters need to be adjusted during travel, this being carried out in an estimation filter 50 in the present embodiment.

In the present embodiment, the estimation filter 50 likewise receives the location data 32 and the additional comparison location data 46, but processes exclusively the speeds from these location data 32, 46 in a manner that is not shown. The basic concept of the estimation filter 50 is that a difference between the location data 32 and the additional comparison location data 46 contains correction values 48 for the tire parameters that the aforementioned odometry model 44 uses for calculating the additional comparison data 46.

To this end, the odometry model 44 makes assumptions about the tire parameters on the basis of a starting value. The actual tire parameters are contained in the location data 32 for this purpose, since said location data are captured by measurement techniques on the basis of the actual speed. Therefore, the model 38 of the present embodiment executes the processing of the position data 8 from the GNSS signal 12 separately from the odometry model 44 so that the odometry model 44 receives no actual location data 32, 34 captured by measurement techniques, which location data could corrupt the estimation of the tire parameters. The estimation filter 50 can determine the correction values 48 for adjusting the tire parameters on the basis of the difference between actual location data 32 and the estimated additional comparison location data 46 in an arbitrary manner. Thus, the estimation filter 50 can form a simple difference between the variables, but may also be in the form of a Kalman filter, which can likewise establish a discrepancy between the location data 32, 46. With particular preference, the filtering also takes account of the variances in the actual location data 32 in order to enhance the quality of the tire parameters.

At this juncture, it should be pointed out that the tire parameters could, in principle, also be derived from a comparison of the comparison location data 34 derived from the GNSS signal 12 and the additional comparison location data 46 from the odometry model 44.

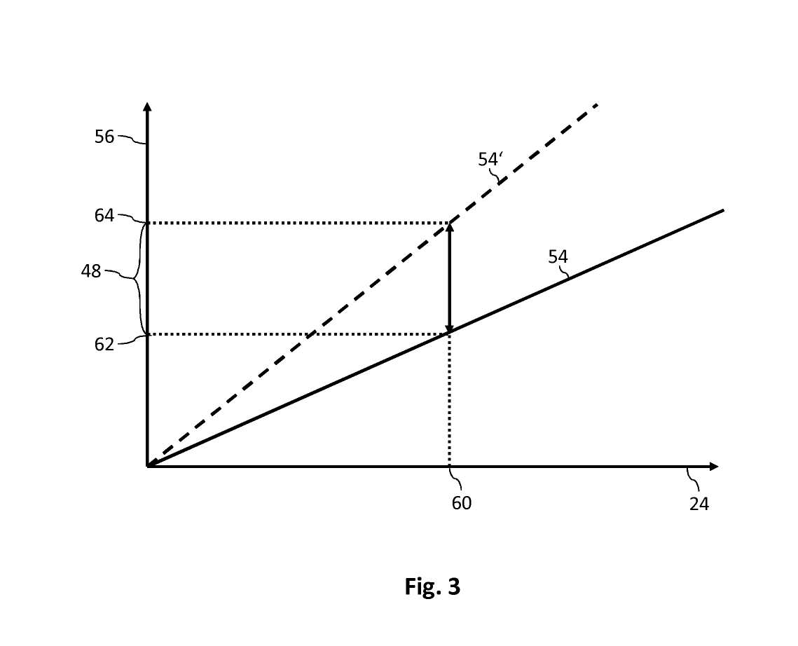

Reference is made to FIG. 3, which will be used to explain correction of a tire parameter, which in this case is assumed to be tire radius, in more detail. FIG. 3 therefore plots a tire radius characteristic 54 which clearly associates a longitudinal speed 56 of the vehicle 2 with a wheel speed 24 of a wheel 26 on the vehicle 2.

The tire radius characteristic 54 is based on the consideration that the tire radius of the wheel 26 can be used to calculate the circumference thereof (U=2rπ). If it is known how quickly the wheel 26 turns per unit time, that is to say the wheel speed 24, then the known circumference of the wheel 26 can be used to calculate the longitudinal speed 56 thereof.

In principle, the tire radius characteristic 54 is linearly rising, which means that the tire radius describes the tire radius characteristic 54 as a gradient. If the tire radius and hence the gradient are incorrect, incorrect longitudinal speeds 56 are associated with the wheel speeds 26 of the vehicle 2 and hence with the corresponding wheels 26.

In the present exemplary embodiment, a correction value 48 is therefore determined for a particular wheel speed value 60. The correction value 60 is determined from the difference between a model value 62 for the longitudinal speed 56, which can be determined on the basis of the currently valid tire radius characteristic 54, and a reference value 64 through which the corrected tire radius characteristic, which is shown in dashes and with the reference symbol 54′ in FIG. 3, should run.

In a new estimation step, the corrected tire radius characteristic 54′ can then be used as a currently valid tire radius characteristic 54, which is then in turn corrected on the basis of a freshly captured reference value 64. In this way, the tire radius characteristic 54 converges with its gradient toward the real tire radius of the relevant wheel 26.

The correction value 58 can subsequently be transmitted to the odometry model 44, which then updates its tire radius characteristic internally. Alternatively, it is also possible for the gradient of the corrected tire radius characteristic 54′ and hence the ascertained corrected tire radius of the corresponding wheel 26 to be transmitted to the odometry model 44.

While the above description constitutes the preferred embodiment of the present invention, it will be appreciated that the invention is susceptible to modification, variation and change without departing from the proper scope and fair meaning of the accompanying claims.

1. A method for estimating tire parameters for a vehicle, comprising:
measuring a reference movement for the vehicle;
modeling of a model movement for the vehicle on the basis of a model that does not include the tire parameters to be estimated; and
estimating the tire parameters of the vehicle on the basis of a juxtaposition of the reference movement and the model movement.

2. The method as claimed in claim 1, further comprising:
detecting the real speed of the vehicle at wheel contact points for the vehicle.

3. The method as claimed in claim 1, further comprising:
setting up the model that does not include the tire parameters to be estimated on the basis of approximated tire parameters.

4. The method as claimed in claim 3 further comprising:
using the estimated tire parameters as approximated tire parameters in the model, in order to estimate new tire parameters.

5. The method as claimed in claim 1 further comprising:
detecting a variance in the reference movement, and
estimating the tire parameters of the vehicle on the basis of the detected variance.

6. The method as claimed in claim 1 further comprising wherein the estimated tire parameters of the vehicle are considered to be valid if one or both the reference movement and the model movement exceed a particular value.

7. The method as claimed in claim 1 further comprising:
juxtaposing the reference movement and the model movement on the basis of an observer.

8. The method as claimed in claim 7, further comprising wherein the observer is a Kalman filter.

9. A control apparatus configured to perform a method for estimating tire parameters for a vehicle, comprising:
measuring a reference movement for the vehicle;
modeling a model movement for the vehicle on the basis of a model that does not include the tire parameters to be estimated; and
estimating the tire parameters of the vehicle on the basis of a juxtaposition of the reference movement and the model movement.

10. A vehicle, comprising a control apparatus (4) configured to carry out a method of measuring a reference movement for the vehicle;
modeling a model movement for the vehicle on the basis of a model that does not include the tire parameters to be estimated; and
estimating the tire parameters of the vehicle on the basis of a juxtaposition of the reference movement and the model movement.
